(19) United States
(12) Patent Application Publication
(10) Pub. No.: US 2005/0232855 A1
(43) Pub. Date: Oct. 20, 2005

(54) Reactor with carbon dioxide fixing material

(75) Inventors: James F. Stevens, Katy, TX (US); Jerry M. Rovner, Houston, TX (US)

Correspondence Address: FRANK C. TURNER;CHEVRON SERVICES COMPANY, LAW DEPARTMENT, P.O. BOX 3725, HOUSTON, TX, 77253-3725, US

(73) Assignees: TEXACO INC., San Ramon, CA (US); TEXACO DEVELOPMENT CORPORATION, San Ramon, CA (US)

(21) Appl. No.: 10/827,600

(22) Filed: Apr. 19, 2004

(51) Int. Cl. C01B 3/24

(52) U.S. Cl. 423/650; 48/127.9

(57) ABSTRACT

Apparatus and methods for converting hydrocarbon fuels to hydrogen-rich reformate that incorporate a carbon dioxide fixing mechanism into the initial hydrocarbon conversion process. The mechanism utilizes a carbon dioxide fixing material within the reforming catalyst bed to remove carbon dioxide from the reformate product. The removal of carbon dioxide from the product stream shifts the reforming reaction equilibrium toward higher hydrocarbon conversion with only small amounts of carbon oxides produced. Fixed carbon dioxide may be released by heating the catalyst bed to a calcination temperature. A non-uniform distribution of catalysts and carbon dioxide fixing material across catalyst bed yields higher conversion rates of hydrocarbon to hydrogen-rich reformate.

### FIELD OF THE INVENTION

The present invention relates to the field of fuel processing wherein hydrocarbon-based fuels are converted into a hydrogen-enriched reformate for ultimate use in hydrogen-consuming devices and processes. The fuel processing methods of the present invention provide a hydrogen-rich reformate of high purity by utilizing absorption enhanced reforming wherein a by-product, such as carbon dioxide, is absorbed from the product stream to shift the conversion reaction equilibrium toward higher hydrocarbon conversion with smaller amounts of by-products produced.

### BACKGROUND OF THE INVENTION

Hydrogen is utilized in a wide variety of industries ranging from aerospace to food production to oil and gas production and refining. Hydrogen is used in these industries as a propellant, an atmosphere, a carrier gas, a diluent gas, a fuel component for combustion reactions, a fuel for fuel cells, as well as a reducing agent in numerous chemical reactions and processes. In addition, hydrogen is being considered as an alternative fuel for power generation because it is renewable, abundant, efficient, and unlike other alternatives, produces zero emissions. While there is wide-spread consumption of hydrogen and great potential for even more, a disadvantage which inhibits further increases in hydrogen consumption is the absence of a hydrogen infrastructure to provide widespread generation, storage and distribution. One way to overcome this difficulty is through distributed generation of hydrogen, such as through the use of fuel reformers to convert a hydrocarbon-based fuel to a hydrogen-rich reformate.

Fuel reforming processes, such as steam reforming, partial oxidation, and autothermal reforming, can be used to convert hydrocarbon fuels such as natural gas, LPG, gasoline, and diesel, into hydrogen-rich reformate at the site where the hydrogen is needed. However, in addition to the desired hydrogen product, fuel reformers typically produce undesirable impurities that reduce the value of the reformate product. For instance, in a conventional steam reforming process, a hydrocarbon feed, such as methane, natural gas, propane, gasoline, naphtha, or diesel, is vaporized, mixed with steam, and passed over a steam reforming catalyst. The majority of the feed hydrocarbon is converted to a mixture of hydrogen and impurities such as carbon monoxide and carbon dioxide. The reformed product gas is typically fed to a water-gas shift bed in which the carbon monoxide is reacted with steam to form carbon dioxide and hydrogen. After the shift step, additional purification steps are required to bring the hydrogen purity to acceptable levels. These steps can include, but are not limited to, methanation, selective oxidation reactions, passing the product stream through membrane separators, as well as pressure swing and temperature swing absorption processes. While such purification technologies may be known, the added cost and complexity of integrating them with a fuel reformer to produce sufficiently pure hydrogen reformate can render their construction and operation impractical.

In terms of power generation, fuel cells typically employ hydrogen as fuel and oxygen as an oxidizing agent in catalytic oxidation-reduction reactions to produce electricity. As with most industrial applications utilizing hydrogen, the purity of the hydrogen used in fuel cell systems is critical. Specifically, because power generation in fuel cells is proportional to the consumption rate of the reactants both their efficiencies and costs can be improved through the use of a highly pure hydrogen reformate. Moreover, the catalysts employed in many types of fuel cells can be deactivated or permanently impaired by exposure to certain impurities. For use in a PEM fuel cell, hydrogen reformate should contain very low levels of carbon monoxide (<50 ppm) so as to prevent carbon monoxide poisoning of the catalysts. In the case of alkaline fuel cells, hydrogen reformats should contain low levels of carbon dioxide so as to prevent the formation of carbonate salts on the electrodes. As a result, an improved yet simplified reforming process capable of providing a high purity hydrogen reformate that is low in carbon oxides is greatly desired.

The disclosure of U.S. Pat. No. 6,682,838, issued Jan. 27, 2004 to Stevens, is incorporated herein by reference.

### SUMMARY OF THE INVENTION

In one aspect of the instant invention, a fuel processing reactor having a catalyst bed comprising a reforming catalyst, a water gas shift catalyst and a carbon dioxide fixing material is provided. The catalyst bed includes an inlet and a plurality of reaction zones in fluid communication with the inlet. The plurality of reaction zones includes an outlet zone proximate an outlet of the catalyst bed. The reforming catalyst, water gas shift catalyst and carbon dioxide fixing material are disposed within the plurality of reaction zones, and in particular, the outlet zone comprises less than 50% by volume of a reforming catalyst. Preferably, the outlet zone will comprise less than 40%, more preferably less than 30%, and still more preferably less than 20% by volume of a reforming catalyst. In some embodiments, the plurality of reaction zones will further include an inlet zone proximate the inlet that comprises a reforming catalyst and an optional water gas shift catalyst. In some embodiments, the outlet zone can include a carbon dioxide fixing material, a water gas shift catalyst, and/or a heat transfer device for removing heat from the outlet zone. Where a heat transfer device is present in the outlet zone, a low temperature water gas shift catalyst can be utilized. In some embodiments, the plurality of reaction zones will further include one or more intermediate zones disposed between the inlet and outlet zones. When present, an intermediate zone will preferably include a mixture of two or more components selected from a reforming catalyst, a carbon dioxide fixing material and a water gas shift catalyst. Optionally, the reactors of the present invention can further include a polishing unit downstream and in fluid communication with the outlet of a catalyst bed, and heat generating means operably connected to the catalyst bed for elevating the temperature of the carbon dioxide fixing material to a calcination temperature. In addition, the reactors of the present invention can further include one or more additional catalyst beds.

In an additional aspect of the instant invention, a fuel processing reactor having a catalyst bed comprising a reforming catalyst, a water gas shift catalyst and a carbon dioxide fixing material is provided. The catalyst bed includes an inlet and a plurality of reaction zones in fluid communication with the inlet. The plurality of reaction zones includes an outlet zone proximate an outlet of the catalyst bed. The reforming catalyst, water gas shift catalyst and carbon dioxide fixing material are disposed within the plurality of reaction zones, and in particular, the outlet zone comprises a water gas shift catalyst and a carbon dioxide fixing material. A heat transfer device is disposed within the catalyst bed for exchanging heat with one or more of the plurality of reaction zones. Where the heat transfer device is at least partially disposed within the outlet zone, the water gas shift catalyst in the outlet zone can be a low temperature water gas shift catalyst. In some embodiments, the plurality of reaction zones further includes an inlet zone proximate the inlet that comprises a reforming catalyst and an optional water gas shift catalyst, which when present is preferably a high temperature water gas shift catalyst. In an optional but preferred embodiment, the plurality of reaction zones will further include one or more intermediate zones disposed between the inlet and outlet zones. When present, an intermediate zone will include a mixture of two or more components selected from a reforming catalyst, a carbon dioxide fixing material and a water gas shift catalyst. Optionally, the reactors of the present invention can further include a polishing unit downstream and in fluid communication with the outlet of the catalyst bed, and heat generating means operably connected to the catalyst bed for elevating the temperature of the carbon dioxide fixing material to a calcination temperature. In addition, the reactors of the present invention can further include one or more additional catalyst beds.

In a process aspect of the present invention, a method for reforming a hydrocarbon fuel in a catalyst bed is provided. The method includes the steps of contacting reforming reactants with a first catalyst composition in a catalyst bed to produce a partially reformed reformate comprising hydrogen, carbon dioxide and unreacted reforming reactants. The first catalyst composition includes a reforming catalyst. The method further includes contacting the partially reformed reformate with a second catalyst composition in the catalyst bed to produce a reformate comprising hydrogen and carbon dioxide. The second catalyst composition includes a reforming catalyst and a carbon dioxide fixing material. The carbon dioxide fixing material fixes at least a portion of the carbon dioxide in the reformate to provide a carbon dioxide-depleted reformate and fixed carbon dioxide. In addition, the method includes the step of contacting the carbon dioxide-depleted reformate with a mixture comprising a carbon dioxide fixing material and less than 50% reforming catalyst to produce a hydrogen-rich reformate.

Optionally, the method can further include removing heat from the carbon dioxide-depleted reformate before contacting the mixture. Where this heat removal step is used, the mixture can comprise a low temperature water gas shift catalyst. In other embodiments, the method can further include heating the carbon dioxide fixing material to a calcination temperature so as to release fixed carbon dioxide and form a calcinated carbon dioxide fixing material. In addition, the calcinated carbon dioxide fixing material can optionally be hydrated with steam to regenerate and sustain the fixing capacity of the carbon dioxide fixing materials. When the carbon dioxide fixing material has been hydrated at a hydration temperature below the reforming temperature, the catalyst bed is heated to the reforming temperature before resuming the reforming reaction by contacting reforming reactants with the first catalyst composition. In still other embodiments, the method will include a polishing step to remove one or more impurities from the hydrogen-rich reformate. When utilized, the polishing step can be selected from the group consisting of water removal, methanation, selective oxidation, pressure swing adsorption, temperature swing adsorption, membrane separation and combinations thereof.

In yet another embodiment, the method can further include the steps of directing the reforming reactants to a second catalyst bed wherein the reforming reactants contact a first catalyst composition to produce a partially reformed reformate comprising hydrogen, carbon dioxide and unreacted reforming reactants. The first catalyst bed in the second catalyst bed comprises a reforming catalyst. The partially reformed reformate is contacted with a second catalyst composition in the second catalyst bed to produce a reformate comprising hydrogen and carbon dioxide. This second catalyst composition includes a reforming catalyst and a carbon dioxide fixing material. The carbon dioxide fixing material fixes at least a portion of the carbon dioxide to provide a carbon dioxide-depleted reformate and fixed carbon dioxide. The method further includes contacting the carbon dioxide-depleted reformate with a mixture comprising a carbon dioxide fixing material and less than 50% reforming catalyst to produce a hydrogen-rich reformats.

### BRIEF DESCRIPTION OF THE DRAWINGS

The invention may be understood by reference to the following description taken in conjunction with the accompanying drawings.

FIG. 1a is a schematic diagram of a reforming apparatus of the instant invention, particularly illustrating the general components that can be utilized in converting a hydrocarbon fuel to a hydrogen-rich reformate.

FIG. 1b is a schematic diagram of a reforming apparatus of the instant invention, particularly illustrating a catalytic burner for heating the catalyst bed to a calcination temperature.

FIG. 2 is a schematic diagram of a catalyst bed of the instant invention.

FIG. 3 is a schematic diagram of a catalyst bed of the instant invention.

FIG. 4 is a flow diagram illustrating a method of the instant invention.

FIG. 5 is a flow diagram illustrating an embodiment of the instant invention for use in continuously producing a hydrogen-rich reformate.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE PREFERRED EMBODIMENTS

Illustrative embodiments of the invention are described below. In the interest of clarity, not all features of an actual embodiment are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover it will be appreciated that such a development effort might be complex and time-consuming, but would nevertheless be a routine undertaking for those of ordinary skill in the art having the benefit of this disclosure.

The instant invention is generally directed to reactors and methods for converting a hydrocarbon fuel to a hydrogen-rich reformate. The instant invention simplifies the production of a highly pure hydrogen-rich reformate by incorporating a carbon dioxide fixing mechanism into the initial hydrocarbon conversion process, specifically, by incorporating a carbon dioxide fixing material into the reforming catalyst(s) bed. Hydrocarbon to hydrogen conversion reactions utilizing such carbon dioxide fixing materials are generally referred to herein as “absorption enhanced reforming” as the absorption or removal of carbon dioxide from the product stream shifts the reforming reaction equilibrium toward higher hydrocarbon conversion with smaller amounts of carbon monoxide and carbon dioxide produced.

Catalyst beds containing two or more components are to an extent known in the hydrocarbon reforming arts, however, such beds typically comprise a uniform distribution of the bed components. As described herein, it has been found that a non-uniform distribution of a reforming catalyst and/or carbon dioxide fixing material across a reforming catalyst bed can be used to achieve higher conversion rates of hydrocarbon to hydrogen-rich reformate with lower levels of carbon oxides produced.

More specifically, the reactors and methods of the instant invention concern the generation of a hydrogen-rich reformate from a hydrocarbon fuel using multiple reactions occurring within a common catalyst bed. Typical reactions that may be performed within the catalyst bed include fuel reforming reactions such as steam and/or autothermal reforming reactions that generate a reformate containing hydrogen, carbon oxides and potentially other impurities. In addition, water gas shift reactions wherein water and carbon monoxide are converted to hydrogen and carbon dioxide and carbonation reactions wherein carbon dioxide is absorbed or chemically converted to species such as carbonates can also occur within the catalyst bed. Chemical equations for such a combination of reactions using methane as the hydrocarbon fuel and calcium oxide as the carbon dioxide fixing material are as follows:
CH₄+H₂O→3H₂+CO (Steam Reforming) (I)
H₂O+CO→H₂+CO₂ (Water Gas Shift) (II)
CO₂+CaO→CaCO₃ (Carbonation) (III)
CH₄+2H₂O+CaO→4H₂+CaCO₃ (Combined) (IV)
While these equations exemplify the conversion of methane to a hydrogen-rich reformate, the scope of the invention should not be so limited. As used herein the term “hydrocarbon fuel” includes organic compounds having C—H bonds which are capable of producing hydrogen from a partial oxidation, autothermal and/or a steam reforming reaction. The presence of atoms other than carbon and hydrogen in the molecular structure of the compound is not excluded. Thus, suitable fuels for use in the method and apparatus disclosed herein can include, but are not limited to, hydrocarbon fuels such as natural gas, methane, ethane, propane, butane, naphtha, gasoline, diesel and mixtures thereof, and alcohols such as methanol, ethanol, propanol, and mixtures thereof. Preferably, the hydrocarbon fuel will be a gas at 30° C., standard pressure. More preferably the hydrocarbon fuel will comprise a component selected from the group consisting of methane, ethane, propane, butane, and mixtures of the same.

A source of water will also be operably connected to the catalyst bed(s). Water can be introduced to the catalyst bed as a liquid or vapor, but is preferably in the form of steam. The ratios of the reactor feed components are determined by the nature of the reforming reaction and desired operating conditions as they affect both operating temperature and yield. In embodiments where the reforming reaction utilizes a steam reforming catalyst, the steam to carbon ratio is typically in the range between about 8:1 to about 1:1, preferably between about 5:1 to about 1.5:1 and more preferably between about 4:1 to about 2:1. When the catalyst bed is being operated in a non-reforming mode, such as when the carbon dioxide fixing material is being heated to a calcination temperature, the flow of steam to the bed will be reduced and in some embodiments interrupted. In addition, it should also be noted that steam temperatures can be varied depending on the mode of operation. For example, steam that is used to hydrate the carbon dioxide fixing material will typically be at a lower temperature than steam that is used for reforming the hydrocarbon fuel.

Hydrocarbon fuel and steam, separately or preferably in a mixture, are directed into a reactor comprising a catalyst bed having an inlet and a plurality of reaction zones in fluid communication with the inlet. Disposed within the plurality of reaction zones are a reforming catalyst, preferably a steam reforming catalyst, a water gas shift catalyst, and a carbon dioxide fixing material. As noted above, the catalyst(s) in this system can promote multiple reactions including a reforming reaction and a shift reaction. The carbon dioxide fixing material is utilized to remove the carbon dioxide from the reformate product shifting the reaction equilibrium toward the production of higher concentrations of hydrogen and lower concentrations of carbon oxides.

The reforming catalyst(s) may be in any form including pellets, spheres, extrudates, monoliths, as well as common particulates and agglomerates. Conventional steam reforming catalysts are well known in the art and can include nickel with amounts of cobalt or a noble metal such as platinum, palladium, rhodium, ruthenium, and/or iridium. The catalyst can be supported, for example, on magnesia, alumina, silica, zirconia, or magnesium aluminate, singly or in combination. Alternatively, the steam reforming catalyst can include nickel, preferably supported on magnesia, alumina, silica, zirconia, or magnesium aluminate, singly or in combination, promoted by an alkali metal such as potassium. Where the reforming reaction is preferably a steam reforming reaction, the reforming catalyst preferably comprises rhodium on an alumina support. Suitable reforming catalysts are commercially available from companies such as Cabot Superior Micropowders LLC (Albuquerque, N.M.) and Engelhard Corporation (Iselin, N.J.).

Reaction temperatures of an autothermal reforming reaction can range from about 550° C. to about 900° C. depending on the feed conditions and the catalyst. In a preferred embodiment, the reforming reaction is a steam reforming reaction with a reforming temperature in the range from about 400° C. to about 800° C., preferably in the range from about 450° C. to about 700° C., and more preferably in the range from about 500° C. to about 650° C.

Certain reforming catalysts have been found to exhibit activity for both reforming and water gas shift reactions. In particular, it has been found that a rhodium catalyst on alumina support will catalyze both a steam methane reforming reaction and a water gas shift reaction under the conditions present in the catalyst bed. In such circumstances, the use of a separate water gas shift catalyst is not required. Where the selected reforming catalyst does not catalyze the shift reaction, the catalyst bed comprises a separate water gas shift catalyst.

The water gas shift catalyst within the catalyst bed is utilized to promote the conversion of steam and carbon monoxide to hydrogen and carbon dioxide. The removal of carbon monoxide by a shift reaction upgrades the value of the hydrogen-rich reformate gas as carbon monoxide is a well known poison to many catalyst systems including those used in fuel cells and petrochemical refining. The maximum level of carbon monoxide in the hydrogen-rich reformate should be a level that can be tolerated by fuel cells, a level that is typically below about 50 ppm. In addition, there is growing demand for even higher purity hydrogen reformate streams that have carbon monoxide concentrations below about 25 ppm, preferably below about 15 ppm, more preferably below 10 ppm, and still more preferably below about 5 ppm.

Water gas shift reactions generally occur at temperatures of from about 150° C. to about 600° C. depending on the catalyst used. Low temperature shift catalysts operate at a range of from about 150° C. to about 300° C. and include for example, copper oxide, or copper supported on other transition metal oxides such as zirconia, zinc supported on transition metal oxides or refractory supports such as silica, alumina, zirconia, etc., or a noble metal such as platinum, rhenium, palladium, rhodium or gold on a suitable support such as silica, alumina, zirconia, and the like. High temperature shift catalysts are preferably operated at temperatures ranging from about 300° C. to about 600° C. and can include transition metal oxides such as ferric oxide or chromic oxide, and optionally include a promoter such as copper or iron silicide. Suitable high temperature shift catalysts also include supported noble metals such as supported platinum, palladium and/or other platinum group members. Because it is envisioned that a heat transfer device(s) may be incorporated into the catalyst bed, both high and low temperature water gas shift catalyst ca be used within different reaction zones of the same catalyst bed.

The catalyst bed will also include a carbon dioxide fixing material. As used in this disclosure, “carbon dioxide fixing material” is intended to refer to materials and substances that react or bind with carbon dioxide at a temperature within the range of temperatures that is typical of hydrocarbon conversion to hydrogen and carbon oxides. Such carbon dioxide fixing materials include, but are not limited to, those materials that will adsorb or absorb carbon dioxide as well as materials that will convert carbon dioxide to a chemical species that is more easily removed from the reformate gas stream. In addition, suitable fixing materials will need to be stable in the presence of steam at reforming temperatures, can maintain a high carbon dioxide fixing capacity over multiple reforming/calcination cycles, are low in toxicity and pyrophoricity, and will preferably be low in cost.

Suitable carbon dioxide fixing materials can comprise an alkaline earth oxide(s), a doped alkaline earth oxide(s) or mixtures thereof. Preferably, the carbon dioxide fixing material will comprise calcium, strontium, or magnesium salts combined with binding materials such as silicates or clays that prevent the carbon dioxide fixing material from becoming entrained in the gas stream and reduce crystallization that decreases surface area and carbon dioxide absorption. Salts used to make the initial bed can be any salt, such as an oxide or hydroxide that will convert to the carbonate under process conditions. Specific substances that are capable of fixing carbon dioxide in suitable temperature ranges include, but are not limited to, calcium oxide (CaO), calcium hydroxide (Ca(OH)₂), strontium oxide (SrO), strontium hydroxide (Sr(OH)₂) and mixtures thereof.

Other suitable carbon dioxide fixing materials can include those materials described in U.S. Pat. No. 3,627,478 issued Dec. 14, 1971 to Tepper, (describing the use of weak base ion exchange resins at high pressure to absorb CO₂); U.S. Pat. No. 6,103,143 issued Aug. 15, 2000 to Sircar et al., (describing a preference for the use of modified double layered hydroxides represented by the formula [Mg₍₁₋ₓ₎Alₓ(OH)₂] [CO₃]_{x/2yH2}O.zM′₂CO₃ where 0.09≦x≦0.40, 0≦y≦3.5, 0≦z≦3.5 and M′=Na or K, and spinels and modified spinels represented by the formula Mg[Al₂]O₄.yK₂CO₃ where 0≦y≦3.5); U.S. Patent Application Publication No. 2002/0110503 A1 published Aug. 15, 2002 by Gittleman et al., (describing the use of metal and mixed metal oxides of magnesium, calcium, manganese, and lanthanum and the clay minerals such as dolomite and sepiolite); and U.S. Patent Application Publication No. 2003/0150163 A1 published Aug. 14, 2003 by Murata et al., (describing the use of lithium-based compounds such as lithium zirconate, lithium ferrite, lithium silicate, and composites of such lithium compounds with alkaline metal carbonates and/or alkaline earth metal carbonates); the disclosures of each of which are incorporated herein by reference. In addition, suitable mineral compounds such as allanite, andralite, ankerite, anorthite, aragoniter, calcite, dolomite, clinozoisite, huntite, hydrotalcite, lawsonite, meionite, strontianite, vaterite, jutnohorite, minrecordite, benstonite, olekminskite, nyerereite, natrofairchildite, farichildite, zemkorite, butschlite, shrtite, remondite, petersenite, calcioburbankite, burbankite, khanneshite, carboncemaite, brinkite, pryrauite, strontio dressenite, and similar such compounds and mixtures thereof, can be suitable materials for fixing carbon dioxide.

One or more of the described carbon dioxide fixing materials may be preferred depending on such variables as the hydrocarbon fuel to be reformed, the selected reforming reaction conditions and the specification of the hydrogen-rich gas to be produced. In addition, the fixing material selected should exhibit low equilibrium partial pressure of carbon dioxide in the temperature range of about 400° C. to about 650° C. and high equilibrium partial pressure of carbon dioxide at temperatures from about 150° C. to about 400° C. above the selected reforming reaction temperature.

The carbon dioxide fixing material may take any of the forms suggested above for catalysts, including pellets, spheres, extrudates, monoliths, as well as common particulates and agglomerates. In addition, the catalyst(s) and carbon dioxide fixing material may be combined into a mixture in one or more of these forms. In a preferred embodiment, the carbon dioxide fixing material will be combined with the selected catalyst(s) to form a mixture that is processed into a particulate using an aerosol method such as that disclosed in U.S. Pat. No. 6,685,762 issued Feb. 3, 2004 to Brewster et al., the contents of which are incorporated herein by reference.

The reactors and methods of the present invention produce an improved reformate composition in part because the carbon dioxide fixing material reacts with or “fixes” carbon dioxide, thereby removing it from the reformate product stream and shifting the reforming reaction equilibrium toward the production of increased molar amounts of hydrogen. Where the carbon dioxide fixing material is calcium oxide, the fixing reaction is a carbonation reaction that produces calcium carbonate as shown in Equation III above.

Testing has shown that a carbon dioxide fixing material will release fixed carbon dioxide when heated to a higher temperature. As used herein, the term “calcine” and its derivatives are intended to refer to those reactions or processes wherein a carbon dioxide fixing material is heated to a temperature at which fixed carbon dioxide is released due to thermal decomposition, phase transition or some other physical or chemical mechanism. A temperature or range of temperatures at which fixed carbon dioxide is released is referred to as a “calcination temperature”. In a preferred embodiment, the calcination temperature for the carbon dioxide fixing material will be above the selected reforming reaction temperature. More specifically, the calcination temperature of the fixing material will be above about 550° C., preferably above about 650° C., and more preferably above about 750° C. Although not to be construed as limiting of suitable carbon dioxide fixing materials, a preferred calcination reaction has the equation:
CaCO₃→CO₂+CaO (calcination) (V).

The carbon dioxide fixing material can be heated to a calcination temperature by flowing heated gas(es) through the bed under conditions at which fixed carbon dioxide is released. Such gases can include heated streams of helium, nitrogen, steam and mixtures of the same, as well as heated exhaust gases from a fuel cell or the tail gas of a metal hydride storage system. In addition, heat exchanging and heat generating means such as are described herein can be used to heat the carbon dioxide fixing material to a calcination temperature. In some embodiments, the carbon dioxide fixing material can be heated to a calcination temperature by heated oxidation products that are produced by an oxidation reaction within the reactor. In such an embodiment, hydrocarbon fuel and oxidant are mixed and oxidized either catalytically or non-catalytically within the reactor.

In a preferred embodiment, an oxidation zone is disposed within the reactor separate from the catalyst bed so that carbon or other oxidation by-products are not deposited within the catalyst bed. Optionally, a heat transfer device can be used to facilitate the transfer of heat between the catalyst bed and the oxidation zone, particularly when the oxidation zone is disposed downstream of the catalyst bed or external to the reactor vessel. The temperature of the oxidation reaction and the heated oxidation products can be adjusted by adjusting the fuel and oxidant feed streams and/or by directing a temperature moderator into the reactor. Suitable temperature moderators can include a fluid material selected from the group consisting of steam, water, air, oxygen depleted air, carbon dioxide, nitrogen or mixtures of the same. Reactors and methods that utilize heated oxidation products to calcinate a carbon dioxide fixing material are described in greater detail in U.S. Patent Application Publication No. 2002/0085967 A1, published Jul. 4, 2002 by Yokata; U.S. Patent Application Publication No. 2003/0150163 A1, published Aug. 14, 2003 by Murata, et al.; and U.S. Patent Application “Reactor and Apparatus for Hydrogen Generation”, by Stevens, et al., Attorney Docket No. X-0186, filed Apr. 19, 2004, the disclosures of each of which is incorporated herein by reference.

Regardless of the means by which the carbon dioxide fixing materials is heated to a calcination temperature, a volume of steam and/or nitrogen can optionally be passed through the bed as a sweep stream for removing released carbon dioxide from the bed.

Repeated reforming/calcination cycles tend to decrease the fixing capacity of the carbon dioxide fixing materials resulting in a reduction of the hydrocarbon to hydrogen conversion rates. In an effort to minimize losses in carbon dioxide fixing capacity, it has been found that hydration of the carbon dioxide fixing material between one or more cycles can to an extent restore and sustain the fixing capacity of such materials at acceptable levels. In addition, it has been found that such hydration improves the reaction efficiencies for both the conversion rate of hydrocarbon fuel to hydrogen and the shift conversion of carbon monoxide to hydrogen and carbon dioxide.

Hydration of the calcinated carbon dioxide fixing material can occur at virtually any time, including but not limited to, after each calcination step, during reactor start-up and/or shut-down procedures, after the performance of a number of reforming/calcination cycles or can be triggered by detecting an undesirable change in reformate composition. By way of example, hydration can be triggered when the level of a monitored reformate component exceeds or falls below a predetermined level that is indicative of when the fixing capacity of the carbon dioxide fixing material has been impaired. Reformate components that can be monitored for this purpose include, but are not limited to, hydrogen, carbon monoxide, carbon dioxide, and unreacted hydrocarbon fuel.

Hydration can be achieved by contacting calcinated carbon dioxide fixing material with water, preferably in the form of steam. After calcination, the catalyst bed is at an elevated temperature relative to the reforming temperature. Hydration is preferably conducted at a hydration temperature that is below the calcination temperature, and more preferably, below the reforming temperature. Specifically, the hydration temperature should be less than 600° C., preferably below about 500° C., more preferably below about 400° C. and even more preferably below about 300° C. For instance, sufficient hydration can be achieved by passing steam at 200° C. through the catalyst bed.

Not to be bound by theory, but in embodiments where the carbon dioxide fixing material is calcium oxide, repeated cycles of fixing/calcinating carbon dioxide tends to compact the calcium oxide and form crystalline-like structures. Through hydration, at least a portion of the calcium oxide is converted with steam to calcium hydroxide. The formation of calcium hydroxide within the catalyst bed tends to break up and disrupt the compacted and crystalline-like structures and thereby increase the surface area of calcium oxide available for carbon dioxide fixing in subsequent cycles.

The amount of steam that is needed to achieve sufficient hydration will vary depending on the volume of the catalyst bed, the surface area of the carbon dioxide fixing materials within the bed, the type of fixing material used, the structure or matrix of catalyst(s) and fixing materials within the bed and the flow rate of steam through the bed. Where the fixing material comprises calcium oxide, sufficient steam should be passed through the catalyst bed to convert at least about 10% of the calcium oxide to calcium hydroxide to achieve the desired effect. More specifically, at least about 0.03 kg of steam per kg of calcium oxide is needed to achieve sufficient hydration. Greater quantities of steam may be needed where flow rates are higher. A more detailed description of the hydration of carbon dioxide fixing materials may be found in U.S. Patent Application entitled “Reforming With Hydration Of Carbon Dioxide Fixing Material”, by Stevens et al., filed on Apr. 19, 2004 (Attorney Docket No. X-0137), the description of which is incorporated herein by reference.

Although conventional catalyst beds having multiple components tend to have a uniform distribution of those components along the reactants' pathway through the bed, it has been found that superior conversion rates can be achieved when the catalyst(s) and carbon dioxide fixing materials have a non-uniform distribution within the bed. Specifically, the catalyst composition nearest the bed inlet should contain an amount of reforming catalyst that is greater than the average level of reforming catalyst across the bed. Similarly, the composition nearest the bed outlet should contain an amount of reforming catalyst that is less than the average level of reforming catalyst across the bed. This non-uniform distribution of reforming catalyst can be achieved by providing a generally smooth distribution of reforming catalyst that decreases across the bed from the inlet to the outlet. In an alternative, a non-uniform distribution of reforming catalyst can be achieved by providing a plurality of reaction zones that have generally decreasing concentrations of reforming catalyst ranging from the inlet to the outlet. It should be noted that neither of such distributions should be interpreted as excluding the possibility that a downstream region or reaction zone within the catalyst bed can have a higher concentration of reforming catalyst than an upstream reaction zone.

A more specific example of a zoned approach is to provide a catalyst bed with a plurality of reaction zones that include an inlet zone located proximate to the bed inlet, an outlet zone located proximate to the bed outlet and one or more optional intermediate zones disposed between the inlet and outlet zones. Such a plurality of reactions zones within the catalyst bed can have the same or similar dimensions, and thus, account for relatively equal volumes of the bed, or alternatively, their dimensions and relative volumes can differ significantly.

In such an embodiment, the inlet zone can comprise a first catalyst composition that includes a reforming catalyst, and an optional water gas shift catalyst. Steam and hydrocarbon fuel are directed into the inlet zone where they contact the first catalyst composition and are converted to a partially reformed reformate comprising hydrogen, carbon monoxide, carbon dioxide, and unreacted steam and hydrocarbon fuel. Preferably, carbon dioxide fixing material is absent or in relatively low concentrations, the inlet zone. When the reactions in the inlet zone include reforming and a high temperature shift, the overall reaction in the inlet zone is endothermic in nature. As a result, higher temperature reactants and more sensible heat can be delivered to the inlet zone, favoring the combined reactions. Furthermore, because a portion of this heat is consumed in the reaction, the partially reformed reformate that passes from the inlet zone is at a reduced temperature at which the carbon dioxide fixing material in the intermediate and/or outlet zones can more effectively fix carbon dioxide.

The intermediate zone can comprise a second catalyst composition comprising two or more of a reforming catalyst, a carbon dioxide fixing material, and a water gas shift catalyst. In a preferred embodiment, the second catalyst composition comprises a reforming catalyst, a carbon dioxide fixing material, and a water gas shift catalyst. The partially reformed reformate contacts the second catalyst composition and is converted to a reformate comprising hydrogen and various impurities such as carbon monoxide, carbon dioxide, and unreacted hydrocarbon fuel. Carbon dioxide that is carried over from the inlet zone and that which is generated within the intermediate zone is at least partially fixed by the carbon dioxide fixing material in the second catalyst composition to produce a carbon dioxide-depleted reformate and fixed carbon dioxide.

The outlet zone comprises a mixture of a carbon dioxide fixing material, and optionally, a water gas shift catalyst, that contacts the carbon dioxide-depleted reformate and fixes an additional portion of carbon dioxide. Most of the carbon dioxide that is produced as a result of the reforming and shift reactions in the inlet and intermediate zones is fixed in the intermediate and outlet zones. Although reforming catalyst can be present in the outlet zone, it is preferred that the outlet zone comprise less than 50% by volume of a reforming catalyst. In preferred embodiments, the outlet zone will comprise less than about 40%, preferably less than about 30%, more preferably less than about 20%, and still more preferably less than about 10% by volume of a reforming catalyst. In a highly preferred embodiment, reforming catalyst will be absent from an outlet zone so that carbon dioxide is not produced by a reforming reaction occurring at or near the catalyst bed outlet.

Reaction temperatures can be achieved by flowing gas(es) such as heated streams of helium, nitrogen, steam, as well as heated exhaust gases from a fuel cell or the tail gas of a metal hydride storage system through the catalyst bed. In an alternative, heat exchanging means for removing heat from and/or delivering heat to the catalyst bed can also optionally be incorporated into the design of the catalyst bed, catalyst bed support means or simply imbedded amongst catalyst bed components. Suitable heat exchanging means will be capable of raising the bed temperature to a reforming temperature and/or to a calcination temperature depending on the operational mode of the reactor. Further, heat from the heat exchanging means can also used to pre-heat feeds to the bed.

Suitable heat exchanging means can be capable of generating heat such as electrically resistant heating coils that are embedded within the catalyst bed. Alternatively, heat exchanging means can comprise heat transfer devices within the catalyst bed that are operably coupled with separate heat generating means. For instance, in a preferred embodiment, the heat exchanging means comprise a heat exchanger coil or heat pipe operably coupled to heat generating means that is capable of providing variable heat so that the amount of heat delivered to the catalyst bed can be adjusted to achieve the appropriate reforming or calcination temperature. In an alternative, two or more heat generating means may be used to provide heat for maintaining the reforming reaction temperature, and separately, heat for calcinating the carbon dioxide fixing material. Suitable heat generating means can include conventional heating units such as resistant heating coils, burners or combustors, and heat exchangers operably connected to a fuel cell and/or hydrogen storage system so as to utilize heated exhaust gases from such systems.

The heating of the catalyst bed for the reforming reaction and/or calcination reaction can be achieved by providing a continuous supply of heat to the bed that is sufficient to achieve and maintain the desired temperature throughout the reaction. In an alternative, the bed may initially be heated to the desired reaction temperature with heating thereafter discontinued as the reaction proceeds. In such an embodiment, the bed temperature is monitored and additional heat provided if needed to maintain a desired reaction temperature.

In another embodiment of the instant invention, a heat transfer device can be utilized to exchange heat from one or more reactions zones. More specifically, such an embodiment comprises a catalyst bed having a reforming catalyst, a water gas shift catalyst and a carbon dioxide fixing material that are disposed within a plurality of reaction zones. The plurality of reaction zones includes an outlet zone proximate an outlet of the catalyst bed that comprises a water gas shift catalyst and a carbon dioxide fixing material. A heat transfer device is disposed within the catalyst bed for exchanging heat with one or more of the plurality of reaction zones and is preferably at least partially disposed within the outlet zone. In such an embodiment, an inlet zone can comprise a first catalyst composition that includes a reforming catalyst, and an optional water gas shift catalyst, and an intermediate zone that comprises a second catalyst composition including two or more of a reforming catalyst, a carbon dioxide fixing material, and a water gas shift catalyst.

When the outlet zone contains a water gas shift catalyst and the reactor is operated in a reforming mode, the removal of heat from the outlet zone favors both the shift and carbon dioxide fixing reactions. Further, the removal of heat from the outlet zone enables the operation of the outlet zone at a reduced temperature relative to the temperatures of the inlet and any intermediate zones. As such, it is possible to use a different carbon dioxide fixing material and/or water gas shift catalyst within the outlet zone than is used in the catalyst compositions of the other reaction zones. By way of example, a high temperature water gas shift catalyst can be disposed in the inlet and/or intermediate zones while a low temperature water gas shift catalyst is utilized in the outlet zone. In addition, the removal of heat from the outlet zone may also eliminate the need to cool the hydrogen-rich reformate before directing the reformate to a downstream unit for polishing, storage or other use.

Reactor vessels and other process equipment described herein may be fabricated from any material capable of withstanding the operating conditions and chemical environment of the reactions described, and can include, for example, carbon steel, stainless steel, Inconel, Incoloy, Hastelloy, and the like. The operating pressure for the reactor vessel and other process units are preferably from about 0 to about 100 psig, although higher pressures may be employed. Ultimately, the operating pressure of the fuel processor depends upon the delivery pressure required of the hydrogen produced. Where the hydrogen is to be delivered to a fuel cell operating in the 1 to 20 kW range, an operating pressure of 0 to about 100 psig is generally sufficient. Higher pressure conditions may be required depending on the hydrogen requirements of the end user. As described herein, the operating temperatures within the reactor vessel will vary depending on the type reforming reaction, the type of reforming catalyst, the carbon dioxide fixing material, the water gas shift catalyst when used, and selected pressure conditions amongst other variables.

The reactors and methods of the instant invention can comprise two or more catalyst beds such that one or more beds are able to generate hydrogen-rich reformate while the remaining beds are being calcinated, with or without hydration. Such an embodiment enables the continuous conversion of hydrocarbon fuel to hydrogen-rich reformate and comprises two or more reforming catalyst beds, a first manifold capable of directing reforming reactants such as hydrocarbon fuel and/or steam between the separate catalyst beds, and a second manifold capable of diverting the effluent of each reforming catalyst bed between a conduit for a carbon dioxide-laden gas and a conduit for the hydrogen-rich reformate.

The conduit for the hydrogen-rich reformate can optionally be connected to one or more polishing units to provide fluid communication between the catalyst bed outlet and polishing unit(s). As used herein, a polishing unit refers to a device or system that can further purify or remove impurities from the hydrogen-rich reformate. Examples of polishing units include drying units, methanation reactors, selective oxidizers, pressure swing adsorption systems, temperature swing adsorption systems, membrane separation systems, and combinations of the same. In some embodiments, the polishing unit is a methanation reactor for converting carbon oxides and hydrogen to methane. Because the level of carbon oxides in the hydrogen-rich reformate is particularly low, the amount of hydrogen that is required to convert the carbon oxides to methane is not considered to be significant. Further, methane can remain in the hydrogen-rich reformate stream without creating a deleterious effect on catalyst systems downstream. In other embodiments, the polishing unit comprises a drying unit for removing water from the hydrogen-rich reformate. In a preferred embodiment, the apparatus comprises a methanation reactor with a drying unit disposed downstream of the methanation reactor. Ultimately, the hydrogen-rich reformate conduit is operably connected to a fuel cell or other hydrogen-consuming device and/or a hydrogen storage device.

In another embodiment of the instant invention, a method for reforming a hydrocarbon fuel is provided. Descriptions of suitable reactors, catalyst bed components, and the like for use in the methods of the invention are provided in detail above.

The method includes the steps of directing reforming reactants, preferably a hydrocarbon fuel and steam, into a catalyst bed. Within the catalyst bed, the reforming reactants contact a first catalyst composition that includes a reforming catalyst and an optional water gas shift catalyst to produce a partially reformed reformate. In a preferred embodiment, the hydrocarbon fuel comprises methane and the reforming catalyst is suitable for catalyzing a steam methane reforming reaction. The partially reformed reformate comprises hydrogen, carbon dioxide and unreacted reforming reactants.

The partially reformed reformate contacts a second catalyst composition within the same catalyst bed to produce a reformate comprising hydrogen and carbon dioxide. The second catalyst composition includes a reforming catalyst, a carbon dioxide fixing material and an optional water gas shift catalyst. The carbon dioxide fixing material in the second catalyst composition fixes at least a portion of the carbon dioxide in the reformate to produce a carbon dioxide-depleted reformate and fixed carbon dioxide.

The carbon dioxide-depleted reformate is contacted with a mixture comprising a carbon dioxide fixing material, an optional water gas shift catalyst, and less than 50% reforming catalyst to produce a hydrogen-rich reformate. Optionally, such a method can further include removing heat from the carbon dioxide-depleted reformate before contacting the mixture or as the carbon dioxide-depleted reformate contacts the mixture. Where this heat removal step is used, the mixture can comprise a low temperature water gas shift catalyst.

In other embodiments, the method can further include heating the carbon dioxide fixing material to a calcination temperature so as to release fixed carbon dioxide and form a calcinated carbon dioxide fixing material. In addition, the calcinated carbon dioxide fixing material can optionally be hydrated with steam to at least partially regenerate and sustain the fixing capacity of the carbon dioxide fixing materials. Once the carbon dioxide fixing material has been hydrated, the catalyst bed can be heated to the reforming temperature before resuming the reforming reaction by directing reforming reactants to the catalyst bed and contacting the reactants with the first catalyst composition therein.

In still other embodiments, the method will include a polishing step to remove one or more impurities from the hydrogen-rich reformate. When utilized, the polishing step can be selected from the group consisting of water removal, methanation, selective oxidation, pressure swing adsorption, temperature swing adsorption, membrane separation and combinations thereof.

In addition, the methods of the present invention can include the steps of calcinating a carbon dioxide fixing material in a first catalyst bed while directing reforming reactants into a second catalyst bed where the reforming reactants are contacted with a first catalyst composition to produce a partially reformed reformate. Also within the second catalyst bed, the partially reformed reformate is contacted with a second catalyst composition that includes a carbon dioxide fixing material to produce a reformate that comprises hydrogen and carbon dioxide. The carbon dioxide fixing material within the second catalyst composition fixes at least a portion of the carbon dioxide in the reformate to produce a carbon dioxide-depleted reformate and fixed carbon dioxide. The carbon dioxide-depleted reformate then contacts a mixture that includes a carbon dioxide fixing material and less than 50% reforming catalyst to produce a hydrogen-rich reformate. Such a method provides for the continuous production of hydrogen by operating one or more catalyst beds in a reforming mode to produce a hydrogen-rich reformate while simultaneously operating one or more other catalyst beds in a non-reforming mode, e.g. calcination and/or hydration, so as to regenerate the carbon dioxide fixing material therein.

### DETAILED DESCRIPTION OF THE FIGURES

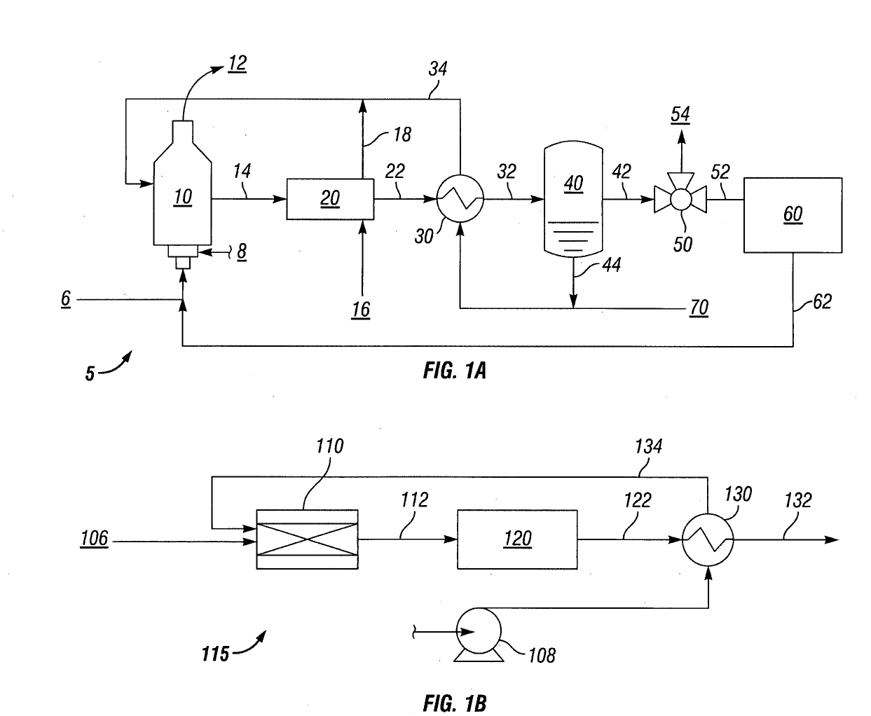

As illustrated in FIG. 1A, apparatus 5 for performing absorption enhanced reforming comprises burner 10 having inlets for fuel 6, fuel gas 62 and air 8. Burner 10 is capable of producing variable heat such that it can provide the heat required for operating catalyst bed 20 in a reforming mode, as well as the heat required for calcinating the carbon dioxide fixing material in calcination mode. Fuel gas 62 is illustrated as being an exhaust or tail gas from hydrogen storage/consuming device 60 and will typically contain at least a portion of unconsumed hydrogen. Fuel 6, fuel gas 62 and air 8 are combusted in burner 10 to generate heat for the reforming reaction in catalyst bed 20. Burner 10 further has exhaust outlet 12.

Feed water 70 is combined with condensed water 44 and is routed through heat exchanger 30 where it is heated with heat from heated gases 22 exiting the catalyst bed. The composition of the heated gases 22 will depend on the operational state of the apparatus 5, namely, whether the catalyst bed is producing reformate, is being calcinated, or is being hydrated. Heated water/steam 34 exiting heat exchanger 30 is then directed to burner 10 for additional pre-heat. Hydrocarbon fuel 16, the hydrocarbon feed to be converted in the catalyst bed to hydrogen-rich reformate, is pre-heated in a heat exchanger (not shown) within catalyst bed 20. Pre-heated hydrocarbon fuel 18 is then directed to burner 10 for additional pre-heating. Feed streams hydrocarbon fuel 18 and steam 34 may be combined prior to pre-heat in burner 10, but are preferably combined intermediate between burner 10 and catalyst bed 20.

When operating in reforming mode, pre-heated steam and hydrocarbon fuel 14 are directed into and through catalyst bed 20 where the hydrocarbon fuel is reformed over the reforming catalyst. The carbon dioxide fixing material within the catalyst bed fixes at least a portion of the carbon dioxide in the reformate. The hydrogen-rich reformate that is produced passes out of the catalyst bed and through heat exchanger 30, reducing the temperature of the reformate. The reformate passes through drying unit 40 where condensing steam drops out of the reformate stream 32. Condensed water 44 recovered in knock out 40 is recycled and combined with feed water 70. Water-depleted reformate 42 then passes though manifold 50 before ultimately being passed onto hydrogen storage/consuming device 60.

During calcination mode, burner 10 is used to superheat steam that is used to raise the temperature of the catalyst bed to a calcination temperature. Upon reaching calcination temperature, carbon dioxide fixed within the catalyst bed is released and flows out of the bed. Carbon dioxide-laden gas 22 passes through heat exchanger 30 and is cooled. The cooled carbon dioxide-laden gas 32 passes through drying unit 40 to condense out at least a portion of the steam. The carbon dioxide gas 42 then passes to manifold 50 where it is directed to vent 54 or preferably a carbon dioxide sequestering unit (not illustrated).

When operated in hydration mode, a flow of lower temperature steam is directed into the catalyst bed following calcination. This low temperature steam serves to cool catalyst bed 20 and to hydrate the calcinated carbon dioxide fixing material within the bed. Upon completion of hydration, the temperature of burner 10 is again increased to provide heat for reforming.

FIG. 1B is a schematic of an absorption enhanced reforming apparatus 115 where a second heat generating means, namely catalytic burner 110, is used to provide the heat for calcinating or regenerating the carbon dioxide fixing material. In this embodiment, a regenerating fuel 106 is supplied to catalytic burner 110. An air source provides regeneration air 108 that is pre-heated in heat exchanger 130. The pre-heated air 134 is then combined with the regeneration fuel 106 and catalytically combusted in burner 110. Superheated exhaust gases 112 from burner 110 are directed into catalyst bed 120 to provide the heat for calcinating the carbon dioxide fixing material therein. Upon reaching the calcination temperature, the carbon dioxide fixing material within the catalyst bed 120 releases fixed carbon dioxide. The carbon dioxide laden gas 122 passes out of the catalyst bed and through heat exchanger 130 where they are cooled. Ultimately, the carbon dioxide gases 132 are directed to vent or carbon dioxide sequestration unit 154.

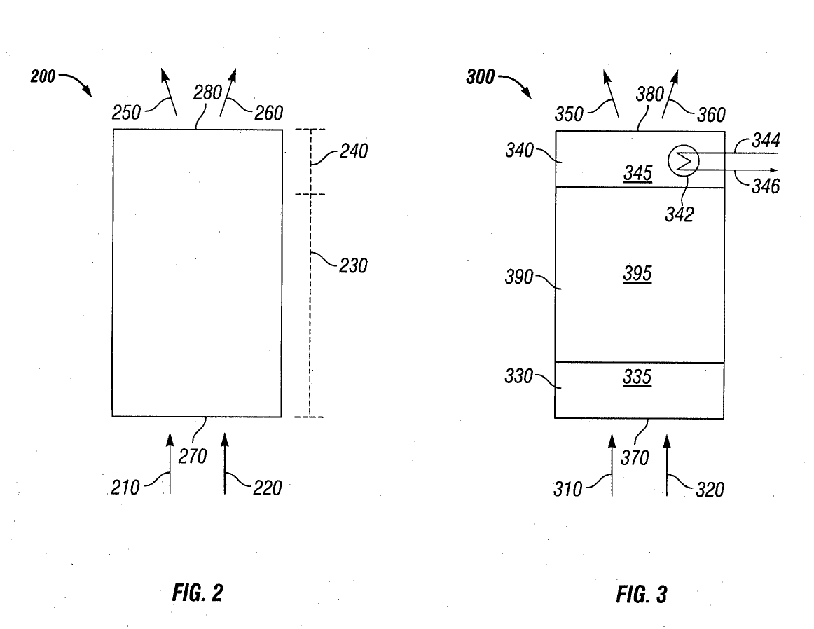

FIG. 2 is a schematic illustration of a catalyst bed suitable for use in the reactors and methods of the instant invention. As shown, preheated reforming reactants of steam 210 and hydrocarbon fuel 220 are directed into the catalyst bed 200 through inlet 270. The catalyst bed includes a reforming catalyst, a water gas shift catalyst and a carbon dioxide fixing material that are disposed within a plurality of reaction zones including outlet zone 240. The proportion of reforming catalyst in outlet zone 240 is lower than the average concentration of reforming catalyst across the bed as a whole. Specifically, outlet zone 240 comprises less than 50% by volume of a reforming catalyst, preferably less than about 40%, more preferably less than about 30% and still more preferably less than about 20% by volume of a reforming catalyst. Upstream of outlet zone 240 is one or more reaction zones 230. Reaction zones 230 comprise a mixture of reforming catalyst, water gas shift catalyst and carbon dioxide fixing material. As is illustrated, the plurality of reaction zones within catalyst bed 200 need not be separated by structural features of the reactor or catalyst bed, but their division can be achieved through the manner or sequence in which the catalyst bed components are loaded into the bed.

Within catalyst bed 200, the reforming reactants are reformed over the reforming catalyst to produce a hydrogen-rich reformate while carbon dioxide is fixed by the carbon dioxide fixing material. When the catalyst bed is operated in a reforming mode, the hydrogen-rich reformate that is produced exits the bed though outlet 280. Outlet 280 is in fluid communication with downstream devices such as hydrogen-consuming device/storage 260. Although not illustrated, one or more intermediate polishing units can be utilized intermediate outlet 280 and hydrogen-consuming device/storage 260.

When the carbon dioxide fixing material within the bed is to be calcinated, the bed is heated to a calcination temperature to release fixed carbon dioxide. The liberated carbon dioxide exits the bed at outlet 280 and is directed to CO₂ sequestration unit or vent 250.

FIG. 3 illustrates catalyst bed 300 that is suitable for use in the methods and reactors of the instant invention. The bed comprises a reforming catalyst, water gas shift catalyst and a carbon dioxide fixing material that are disposed within a plurality of reaction zones, namely inlet zone 330, intermediate zone 390 and outlet zone 340. Division or separation of the reaction zones can be achieved through the use of screens, perforated wall segments, or merely through the sequence of loading the different catalyst bed components and compositions. Disposed within outlet zone 340 is mixture 345 that includes a water gas shift catalyst and a carbon dioxide fixing material. Also disposed within catalyst bed 300 is heat transfer device 342. As illustrated, heat transfer device is at least partially disposed within outlet zone 340. Heat transfer device 342 is a heat exchanger having a cooling medium that circulates into and out of the bed through lines 344 and 346. Although not illustrated, lines 344 and 346 are in fluid communication with a source for the cooling medium and means for removing heat from the cooling medium. Because of the presence of heat exchanger 342, the water gas shift catalyst in mixture 345 is a low temperature shift catalyst, while the shift catalyst disposed within inlet zone 330 and/or intermediate zone 390 is a high temperature shift catalyst.

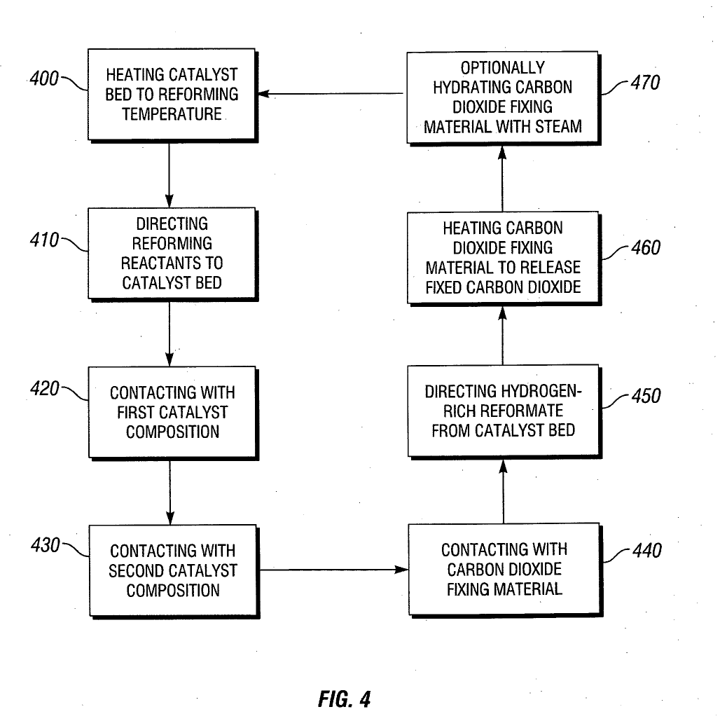

FIG. 4 is a block flow diagram illustrating a method of the instant invention. Specifically, the catalyst bed is heated to a reforming temperature (block 400). Once the temperature of the bed reaches a reforming temperature, reforming reactants can be directed into the catalyst bed (block 410). Within the catalyst bed, the reforming reactants are contacted with a first catalyst composition (block 420) comprising a reforming catalyst and an optional water gas shift catalyst to produce a partially reformed reformate. The partially reformed reformate contacts a second catalyst composition that includes a reforming catalyst, a carbon dioxide fixing material and an optional water gas shift catalyst (block 430) to produce a carbon-dioxide-depleted reformate and fixed carbon dioxide. The carbon-dioxide-depleted reformate is then contacted with a mixture (block 440) comprising a carbon dioxide fixing material, an optional water gas shift catalyst and less than 50% by volume of a reforming catalyst to produce a hydrogen-rich reformate having low levels of carbon oxide impurities and fixed carbon dioxide. This hydrogen-rich reformate is directed out of the bed for further processing, storage or use (block 450). To regenerate the carbon dioxide fixing materials, the catalyst bed and carbon dioxide fixing materials are heated to a calcination temperature to release fixed carbon dioxide (block 460) and form a calcinated carbon dioxide fixing material. Optionally, the calcinated carbon dioxide fixing material can be hydrated with steam to at least partially restore and sustain the carbon dioxide fixing capacity of the fixing materials (block 470). If hydration is not utilized, the calcinated carbon dioxide fixing materials are allowed to cool to a reforming temperature before resuming or initiating the reforming reaction (block 410). When the calcinated fixing materials have been hydrated, the catalyst bed is at a temperature that is below a reforming temperature and may require re-heating (block 400) before resuming or initiating the reforming reaction.

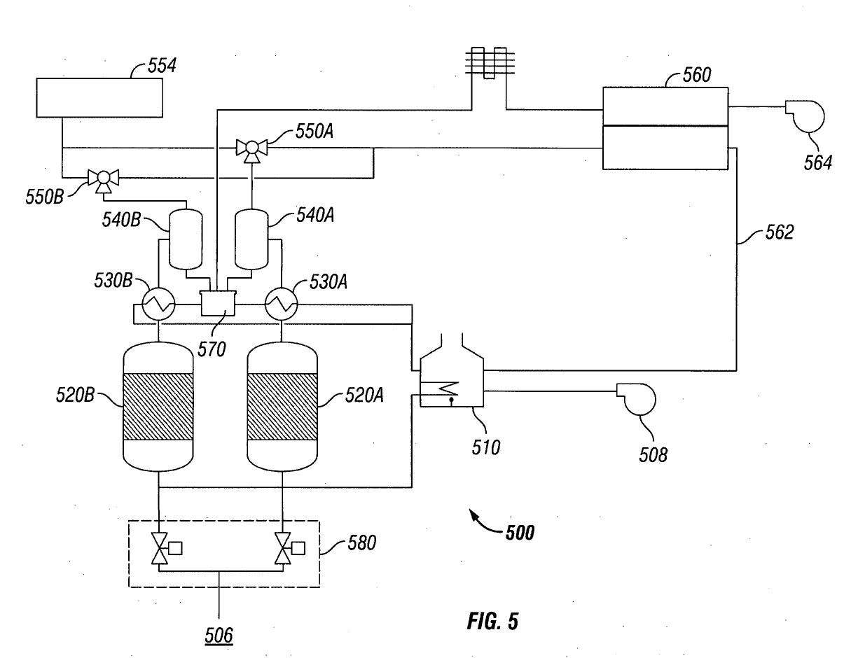

FIG. 5 is a schematic illustration of a reactor system having two catalyst beds 520A and 520B. Heat for operating the catalyst beds in either a reforming mode and/or a non-reforming mode is provided by superheater 510. Reforming reactants, illustrated as hydrocarbon fuel/steam 506, are directed into one or more of the catalyst beds through manifold 580 wherein the reactants are converted to a hydrogen-rich reformate. When one or more of the beds is operated in a regeneration mode, the bed is heated to a calcination temperature to release fixed carbon dioxide.

Depending on the mode of operation, manifolds 550A and 550B direct a hydrogen-rich reformate to fuel cell 560 or a carbon dioxide laden gases to exhaust 554 or sequestration unit (not shown). As illustrated, the multi-bed reactor system is connected to fuel cell 560 to provide hydrogen-rich reformate to the fuel cell anode. Anode tail gas 562, which includes an unreacted portion of the hydrogen-rich reformate, is directed to the burner of superheater 510 as an additional fuel for combustion. Superheater 510 also has combustion air source 508. Cathode exhaust exiting the fuel cell includes heated water vapor that is condensed and recovered in tank 570. Similarly, water vapor recovered from the gases exiting the catalyst beds in drying units 540A and 540B respectively, are recovered in tank 570 and directed to superheater 510 for use in generating steam. Additionally, heat is recovered from gases exiting the catalyst bed in heat exchangers 530A and 530B. By providing catalyst beds 520A and 520B it is possible to produce a continuous supply of hydrogen-rich reformate even while one of the catalyst beds is in a non-reforming mode of operation such as calcination or hydration.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A fuel processing reactor, the reactor comprising:
a catalyst bed comprising:
an inlet;
a plurality of reaction zones in fluid communication with the inlet, the plurality of reaction zones comprising an outlet zone proximate an outlet; and
a reforming catalyst, a water gas shift catalyst and a carbon dioxide fixing material disposed within the plurality of reaction zones, the outlet zone comprising less than 50% by volume of a reforming catalyst.

2. The reactor of claim 1, wherein the plurality of reaction zones comprises an inlet zone proximate the inlet, the inlet zone comprising a reforming catalyst.

3. The reactor of claim 2, wherein the inlet zone further comprises a water gas shift catalyst.

4. The reactor of claim 1, wherein the outlet zone further comprises a carbon dioxide fixing material and/or a water gas shift catalyst.

5. The reactor of claim 4, wherein the outlet zone further comprises a heat transfer device for removing heat from the outlet zone.

6. The reactor of claim 2, wherein the plurality of reaction zones comprises an intermediate zone disposed between the inlet and outlet zones.

7. The reactor of claim 6, wherein the intermediate zone comprises a mixture of two or more of a reforming catalyst, a carbon dioxide fixing material and a water gas shift catalyst.

8. The reactor of claim 1, wherein the outlet zone comprises less than about 40% by volume of a reforming catalyst.

9. The reactor of claim 8, wherein the outlet zone comprises less than about 30% by volume of a reforming catalyst.

10. The reactor of claim 9, wherein the outlet zone comprises less than about 20% by volume of a reforming catalyst.

11. The reactor of claim 1, further comprising one or more additional catalyst beds.

12. The reactor of claim 1, further comprising a polishing unit in fluid communication with the outlet of the catalyst bed.

13. The reactor of claim 1, further comprising heat generating means operably connected to the catalyst bed for delivering heat to the catalyst bed.

14. A fuel processing reactor, the reactor comprising:
a catalyst bed comprising:
an inlet;
a plurality of reaction zones in fluid communication with the inlet, the plurality of reaction zones comprising an outlet zone proximate an outlet;
a reforming catalyst, a water gas shift catalyst and a carbon dioxide fixing material disposed within the plurality of reaction zones, the outlet zone comprising a water gas shift catalyst and a carbon dioxide fixing material; and
a heat transfer device disposed within the catalyst bed for exchanging heat with one or more of the plurality of reaction zones.

15. The reactor of claim 14, wherein the plurality of reaction zones comprises an inlet zone proximate the inlet, the inlet zone comprising a reforming catalyst.

16. The reactor of claim 15, wherein the inlet zone further comprises a water gas shift catalyst.

17. The reactor of claim 16, wherein the water gas shift catalyst in the inlet zone is a high temperature shift catalyst.

18. The reactor of claim 14, wherein the heat transfer device is at least partially disposed within the outlet zone.

19. The reactor of claim 18, wherein the water gas shift catalyst in the outlet zone is a low temperature shift catalyst.

20. The reactor of claim 15, wherein the plurality of reaction zones comprises an intermediate zone disposed between the inlet and outlet zones.

21. The reactor of claim 20, wherein the intermediate zone comprises a mixture of two or more of a reforming catalyst, carbon dioxide fixing material and a water gas shift catalyst.

22. The reactor of claim 14, further comprising one or more additional catalyst beds.

23. The reactor of claim 14, further comprising a polishing unit in fluid communication with the outlet of the catalyst bed.

24. The reactor of claim 14, further comprising heat generating means operably connected to the catalyst bed for delivering heat to the catalyst bed.

25. A method for reforming a hydrocarbon fuel in a catalyst bed, the method comprising the steps of:
contacting reforming reactants with a first catalyst composition in a catalyst bed to produce a partially reformed reformate comprising hydrogen, carbon dioxide and unreacted reforming reactants, the first catalyst composition comprising a reforming catalyst;
contacting the partially reformed reformate with a second catalyst composition in the catalyst bed to produce a reformate comprising hydrogen and carbon dioxide, the second catalyst composition comprising a reforming catalyst and a carbon dioxide fixing material, the carbon dioxide fixing material fixing at least a portion of the carbon dioxide in the reformate to provide a carbon dioxide-depleted reformate and fixed carbon dioxide; and
contacting the carbon dioxide-depleted reformate with a mixture comprising a carbon dioxide fixing material and less than 50% reforming catalyst to produce a hydrogen-rich reformate.

26. The method of claim 25, wherein the reforming reactants comprise hydrocarbon fuel and steam.

27. The method of claim 25, wherein the first catalyst composition further comprises a water gas shift catalyst.

28. The method of claim 25, wherein the second catalyst composition further comprises a water gas shift catalyst.

29. The method of claim 25, wherein the mixture further comprises a water gas shift catalyst.

30. The method of claim 25, further comprising the step of removing heat from the carbon dioxide-depleted reformate before contacting the carbon dioxide-depleted reformate with the mixture.

31. The method of claim 30, wherein the mixture comprises a low temperature water gas shift catalyst.

32. The method of claim 25, further comprising the step of heating the carbon dioxide fixing material to a calcination temperature to release fixed carbon dioxide and form a calcinated carbon dioxide fixing material.

33. The method of claim 32, further comprising the step of hydrating the calcinated carbon dioxide fixing material with steam.

34. The method of claim 33, further comprising the step of heating the catalyst bed to a reforming temperature before contacting the reforming reactants with the first catalyst composition.

35. The method of claim 25, further comprising polishing the hydrogen-rich reformate to remove one or more impurities, the polishing step selected from the group consisting of water removal, methanation, selective oxidation, pressure swing adsorption, temperature swing adsorption, membrane separation and combinations thereof.

36. The method of claim 32, wherein the carbon dioxide fixing material is heated to a calcination temperature within a first catalyst bed and the method further comprises the steps of:
directing reforming reactants to a second catalyst bed;
contacting the reforming reactants with a first catalyst composition in the second catalyst bed to produce a partially reformed reformate comprising hydrogen, carbon dioxide and unreacted reforming reactants, the first catalyst bed in the second catalyst bed comprising a reforming catalyst;
contacting the partially reformed reformate with a second catalyst composition in the second catalyst bed to produce a reformate comprising hydrogen and carbon dioxide, the second catalyst composition in the second catalyst bed comprising a reforming catalyst and a carbon dioxide fixing material, the carbon dioxide fixing material fixing at least a portion of the carbon dioxide to provide a carbon dioxide-depleted reformate and fixed carbon dioxide; and
contacting the carbon dioxide-depleted reformate with a mixture comprising a carbon dioxide fixing material and less than 50% reforming catalyst to produce a hydrogen-rich reformate.
